(19) United States
(12) Patent Application Publication
(10) Pub. No.: US 2008/0004838 A1
(43) Pub. Date: Jan. 3, 2008

(54) Air-Speed Wind Tunnel Data Analysis Suite

(75) Inventors: Charles B. Yungkurth, Tucson, AZ (US); Jeffrey A. Becker, Laurel, MD (US); Richard R. Heisler, Millersville, MD (US)

Correspondence Address: THE JOHNS HOPKINS UNIVERSITYAPPLIED PHYSICS LABORA;OFFICE OF PATENT COUNSEL, 11100 JOHNS HOPKINS ROAD, MAIL STOP 7-156, LAUREL, MD, 20723-6099, US

(73) Assignee: THE JOHNS HOPKINS UNIVERSITY, Baltimore, MD (US)

(21) Appl. No.: 11/608,270

(22) Filed: Dec. 8, 2006

Related U.S. Application Data
(60) Provisional application No. 60/748,462, filed on Dec. 8, 2005.

(51) Int. Cl. G01M 9/02

(52) U.S. Cl. 702/182

(57) ABSTRACT

A system for planning and supporting a testing routine in a fluidic chamber, such as a wind tunnel, including a controller for downloading first data related to one or more fluidic chambers, the first data including cost and run-time information for each of the one or more fluidic chambers, comparing the first data to second data corresponding to predetermined constraints, determining one or more run plans based upon the comparison, selecting an optimized run plan from the one or more run plans according to cost and time constraints, and displaying the optimized run plan. Thereafter, when obtaining substantially real-time data during an aerodynamic test, the controller compares the test data to one or more predetermined threshold values, determines whether the test data corresponds with the one or more predetermined threshold values during a corresponding test, and informs of the result of the determination during the test so that a run can be repeated if necessary during the test.

### CROSS-REFERENCE TO RELATED APPLICATIONS

This application claims priority to prior filed, co-pending U.S. Provisional Application No. 60/748,462 filed on Dec. 8, 2005, the entirety of which is incorporated herein by reference.

### STATEMENT OF GOVERNMENTAL INTEREST

This invention was made with Government support under NAVSEA Contract No. N00024-98-D-8124, awarded by the U.S. Navy. The Government has certain rights in the invention.

### BACKGROUND OF THE INVENTION

1. Field of the Invention

The present invention relates to a system and method for monitoring test conditions for estimating the aerodynamic properties of a vehicle, and more particularly to a system and a method for planning aerodynamic tests, monitoring aerodynamic test conditions/results in real-time, and providing complete post test analysis capabilities for the purpose of creating multidimensional tabulations suitable for incorporation into a six degree-of-freedom (6-DOF) simulation.

2. Description of the Related Art

Since the dawn of aviation, aerodynamic tests have been conducted on airframes in an effort to determine the aerodynamic properties of these airframes.

A typical wind tunnel test requires a large amount of preparation time to estimate the desired test conditions, determine how much tunnel occupancy time is required, prepare the models, and determine how and where to place sensors. After, running a wind tunnel test on a given airframe, the collected test data must be analyzed. Malfunctioning or faulty equipment can result in faulty data which is useless and must be identified and invalidated. This data verification can take a great deal of effort and if the amount of erroneous data is significant, a new wind tunnel test may have to be conducted on the airframe which can take a great deal of time and effort. Unfortunately, it can take several days, weeks, or months to analyze aerodynamic test data and identify any faulty data which should be invalidated. Thereafter, in order to run an aerodynamic wind tunnel test, the previously run test must be set up anew and rerun, at great cost. In other words, conventional methods for obtaining aerodynamic data are not robust in monitoring the data and the consequences are usually very expensive.

Accordingly, in order to maximize the amount of data obtained during any given test, a disproportionate amount of effort must be spent updating and optimizing the corresponding aerodynamic test run plan to reflect the test progress, results, and modifications. Unfortunately, erroneous data, which is typically caused by human error, malfunctioning equipment, and/or tunnel errors, can frequently obviate data obtained during even the most opportunely planned test run. Accordingly, the aerodynamic test run must be repeated at great cost and time.

### SUMMARY OF THE INVENTION

Accordingly, there is a need when developing a well structured wind tunnel test program by providing a means for a user to plan a wind tunnel test program using estimated run times, model change times, and tunnel cost factors. Accordingly, the aerodynamic wind tunnel test plan can be precisely tailored and optimized to the amount of wind tunnel test time purchased. The built in run and model monitoring capabilities according to the present invention reduces or entirely eliminates erroneous test runs due to tunnel errors or equipment malfunctions. Accordingly, it is an aspect of the present invention to immediately identify errors using computerized code and allowing the affected runs to be rerun immediately in a timely and efficient manner.

It is another aspect of the present invention to provide a built in test (BIT) data monitoring capability of the tunnel and/or specific run conditions thereby allowing a user to graphically monitor and analyze the primary aerodynamic channels that are the ultimate end product of the test.

According to another aspect of the present invention, there is provided a system and method for merging, smoothing, incrementing and manipulating test run data in a predetermined fashion for supporting modeling suitable for incorporation into a 6-DOF format.

According to a further aspect of the present invention, there is provided a system and method for evaluating and monitoring in-test data in real time and alerting the system and/or user of “out-of-spec” conditions. Accordingly, according to the present invention a data analysis suite, hereinafter referred to as “AirSpeed,” maintains a run matrix of the facility provided runs and a table matrix of processed and manipulated data runs which may be accessed during any given test and informs a user (i.e., the wind tunnel customer) who can then notify an operator of the test facility of any out-of-spec. Conditions. Alternatively, the AirSpeed can directly notify the operator of the test facility of the out-of-spec condition, thus saving valuable wind tunnel time (e.g., which can include run time and model change times).

According to yet another aspect of the present invention to provide a system and a method for recording manipulated test run data according to a predetermined conditions and outputting data into multidimensional tables which can be read by conventional aerodynamic model software.

Accordingly, it is an aspect of the present invention to provide a system and a method for planning and supporting a testing routine in a fluidic chamber, including a controller for downloading first data related to one or more fluidic chambers, the first data including cost and run-time information for each of the one or more fluidic chambers, comparing the first data to second data corresponding to predetermined constraints, determining one or more run plans based upon the comparison, selecting an optimized run plan of the one or more run plans, and displaying the optimized run plan.

It is yet a further aspect of the present invention to provide a system including a common data base for receiving test data obtained during the optimized run plan, wherein the controller receives test data during a corresponding test. The controller then compares the test data to one or more threshold values and determines whether the test data corresponds with the one or more threshold values during a corresponding test.

### BRIEF DESCRIPTION OF THE DRAWINGS

The above and other objects, features and advantages of the present invention will become more apparent from the following detailed description when taken in conjunction with the accompanying drawings.

FIG. 1 is a block diagram illustrating a system for implementing the AirSpeed wind tunnel data analysis suite according to the present invention.

FIG. 2 is a block diagram of a computer for implementing the system and method according to the present invention.

FIG. 3 is a flow chart illustrating a method for planning and supporting the aerodynamic force and moment wind tunnel tests according to the present invention.

FIG. 4 is a screen-shot illustrating the pre-test planning stage according to the present invention.

FIG. 5 is a flow chart illustrating an in-test support procedure using the AirSpeed program operating in a system according to the present invention.

FIG. 6 is a screen shot illustrating a wind tunnel test matrix and a corresponding graph according to the present invention.

FIG. 7 is a screen shot illustrating a wind tunnel test matrix and a corresponding graph according to the present invention.

### DESCRIPTION OF THE PREFERRED EMBODIMENTS

The following detailed description of the preferred embodiments of the present invention will be made with reference to the accompanying drawings. In describing the invention, explanations about related functions or constructions which are known in the art will be omitted for the sake of clarity in understanding the concept of the invention.

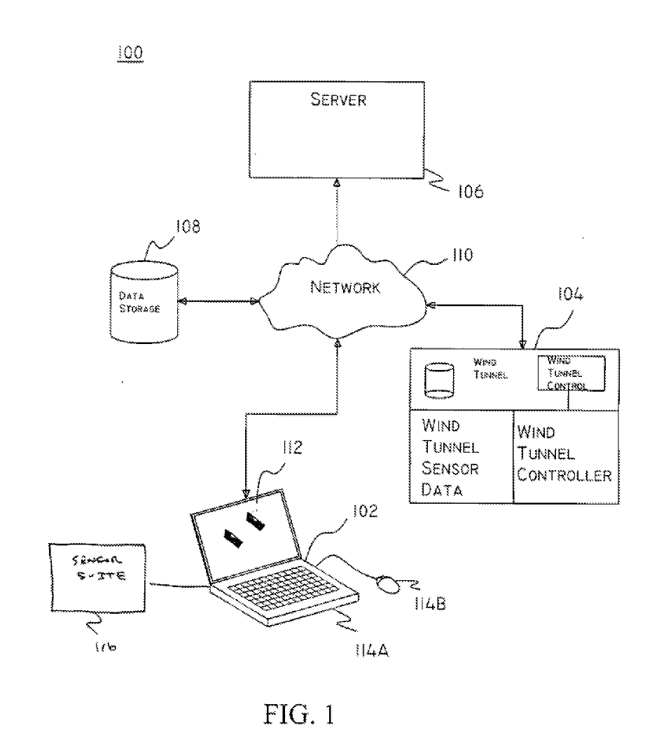

A block diagram illustrating a system for implementing the AirSpeed wind tunnel data analysis suite according to the present invention is shown in FIG. 1. A computer 102 communicates (via wired and/or wireless connections) with a wind tunnel data system 104, data storage 108, optional sensor suite 116, and/or server 106 via network 110. The computer may include any conventional computer such as, for example, a personal computer (PC), a workstation, a proprietary computer, etc., and/or combinations thereof. The computer 102 preferably includes display means such as display 112 and input means such as one or more of a keyboard (KB) 114A, a pointing device such as a mouse 114B and/or a touch-screen display (not shown) and/or other input/output means for input and/or output of data such as data from the optional sensor suite 116 and from wired and/or wireless connections. It is also envisioned that the input means can be located remotely from the computer 102.

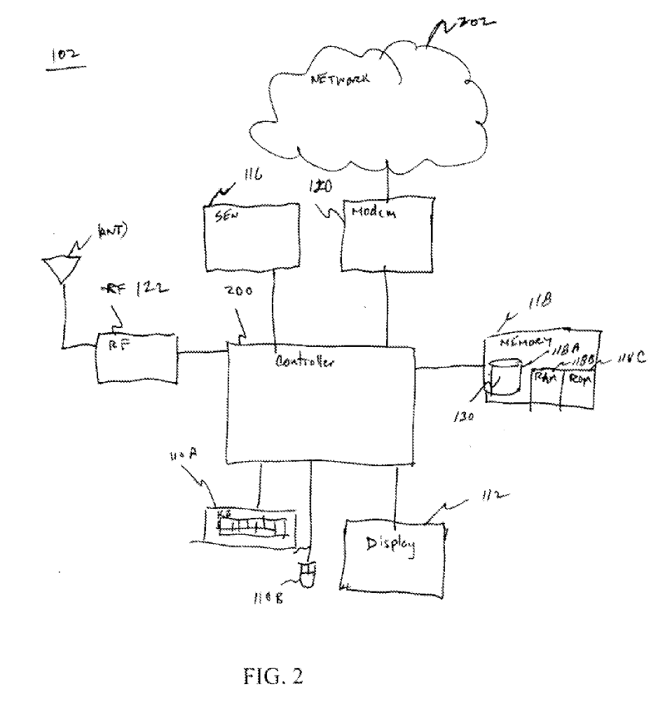

FIG. 2 is a block diagram of the computer 102 for implementing the system and method according to the present invention. The computer 102 includes the keyboard and pointing devices 114A and 114B, respectively, the display 114, a memory 118, a modem 120, optional input means for input and/or output of data to and/or from outside devices such as the optional sensor suit 116, and modulation/transmission means 122 including an antenna (ANT). The modem is used for communicating with the network 202. The memory 118 includes data storage areas for saving programs (such as the AirSpeed integrated software suite of tools according to the present invention) for operating the system and method of the present invention. Accordingly, the memory may include a random access memory (RAM), a read only memory (ROM), a flash memory, one or more hard discs, etc. for storing data and operating programs according to the present invention. The modulation/transmission means 122 is used for modulating/demodulating data for transmission/reception via the antenna (ANT) or optical communication means (not shown—such as infrared device). For example, the modulation/transmission means 122 can be used to transmit/receive data via a Bluetooth and/or IrDA (Infra-red Data Association) connection. Although the modulation/transmission means is shown separated from the modem 120, the modulation/transmission means may be formed integrally with the modem 120.

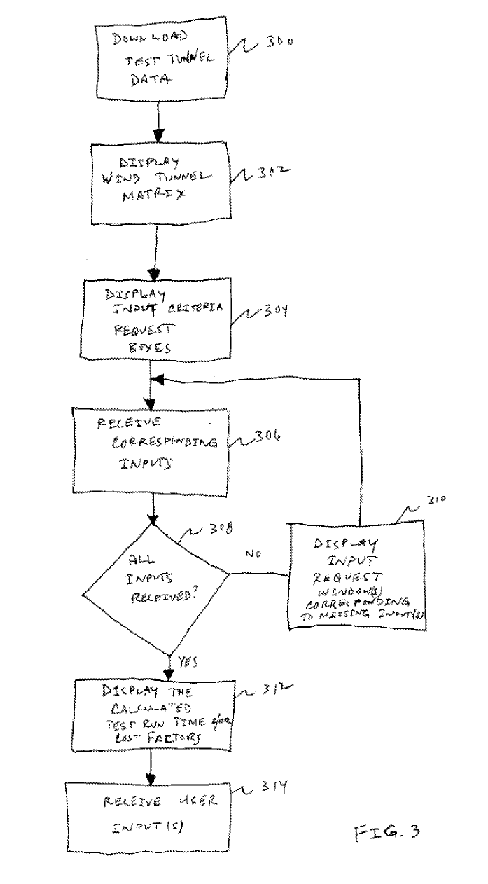

FIG. 3 is a flow chart illustrating a method for planning and supporting the aerodynamic force and moment wind tunnel tests according to the present invention. After initializing the method according to the present invention, the system obtains test tunnel data corresponding to one or more test tunnels from an internal data base (not shown) or from other wind tunnels (via for example, the network 110, the Internet, etc.). The system then proceeds to 302 in which a wind tunnel data matrix is optionally displayed. Then, in step 304, one or more input requests are displayed using, for example, one or more optional input dialog boxes are superposed upon the wind tunnel data matrix. The system then receives corresponding inputs in step 306 and proceeds to step 308 in which it is determined whether all inputs have been received (by for example, a user input or a data download).

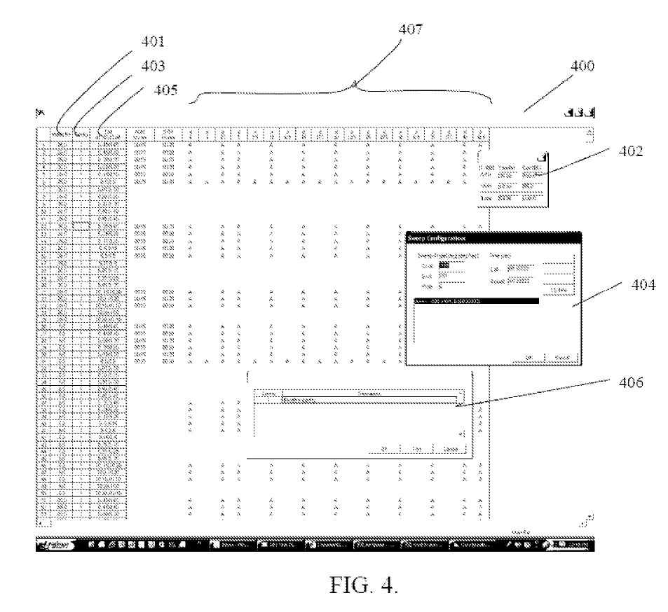

In step 308, if it is determined that all inputs have been received, the system continues to step 312 and sets the corresponding inputs. However, in step 308, if it is determined that all inputs have not been received, the process continues to step 310, wherein an input request is displayed to request input of the corresponding missing input(s). Then step 306 is repeated. Then, in step 312, using parameters provided by the user that include aircraft or missile test type, desired Mach and Reynolds number conditions, desired data sweep parameters and ranges, model configuration descriptions (such as when comparing two competing designs), control surface deflections, and/or parameters provided by corresponding wind tunnels such as estimated run times, model change times, user occupancy costs, and air-on operating costs, the system according to the present invention will calculate an estimated cost and time required to conduct the desired test plan based on the input variables. Thereafter, in step 314, the calculated estimated cost and time required to conduct the desired test are displayed to the user and the user can then add or delete desired runs and or test conditions to create a test plan that meets airframe design, cost, and schedule constraints. In addition AirSpeed provides a means to compare estimated test time and costs between competing facilities. By simply modifying the previously input and optimized test matrix to reflect the new facilities cost and run rates, a second estimated matrix can be generated to aid in choosing which facility is best suited for conducting the desired test. This process can be repeated multiple times for as many facilities as desired. The above-described process for determining a suitable wind tunnel test configuration according to the present invention is illustrated in further detail with reference to FIG. 4 below.

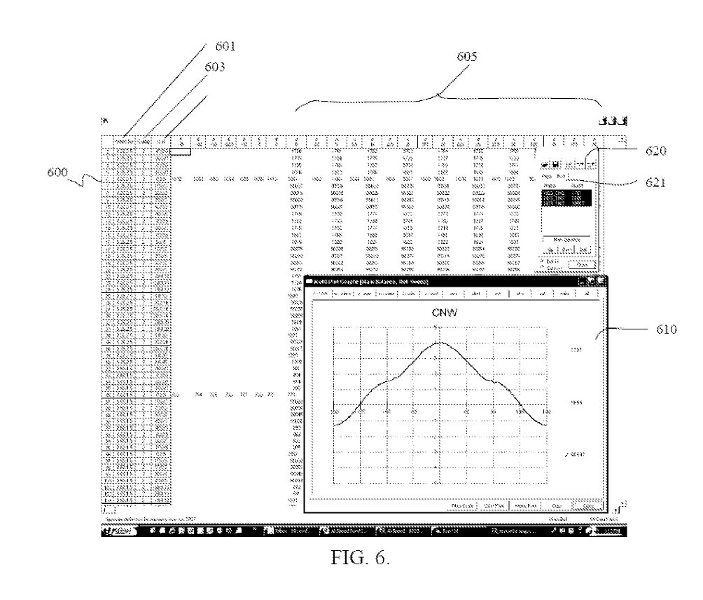

A screen shot illustrating a test matrix and user input boxes according to the present invention is shown in FIG. 4. The wind tunnel test matrix 400 includes data corresponding to test variables such as desired Mach ranges 401, Configuration number 403, airframe specific settings such as Tail deflection 405, etc. Estimated test time and cost are shown in a Cost Summary box 402 (based on previously entered facility occupancy costs), sweep angle and time in Dialog box 404, and Configuration (e.g., corresponding to Configuration number 403) in Dialog box 406. Other test data such as Mach and Reynolds numbers, fin deflection, pitch, roll, and/or sideslip angles corresponding to a given condition, sweep range and foul indication, will be described below with respect to FIG. 6.

After a wind tunnel test configuration is determined, the system and method according to the present invention provides in-test support which will be described below.

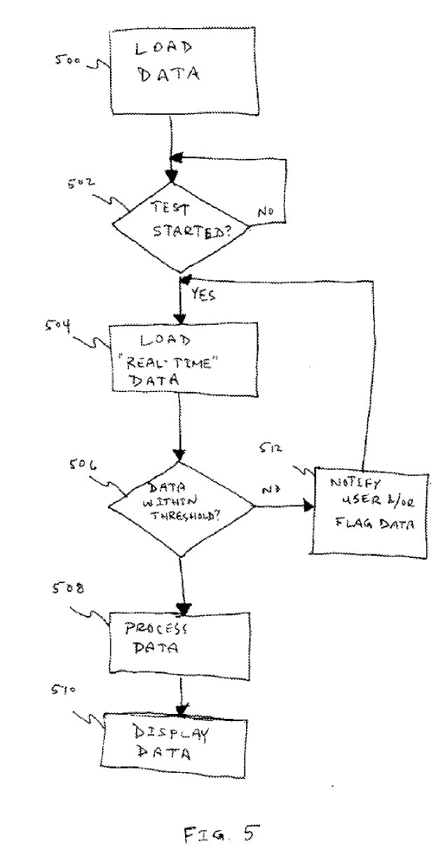

A flow chart illustrating an in-test support procedure using the AirSpeed program operating in a system according to the present invention is shown in FIG. 5. Basically, the present invention provides a system and method for supporting the aerodynamic force and moment wind tunnel tests described above.

With reference to FIG. 5, the system according to the present invention loads test data in step 500. The test data can include information corresponding to the selected wind tunnel and user-selected parameters (e.g., wind tunnel test configuration, sweep time, etc.) The system uses this test data to determine corresponding thresholds as will be described below. For example, the sweep range can be used to determine a sweep range threshold range (e.g., from −50 to 50 deg.). The test data and other data can be stored in the common data storage area and downloaded by the AirSpeed program at any time.

In step 502, it is determined if the wind tunnel test has begun. For example, the system can determine that the wind tunnel test has begun by detecting a user-entered command, a signal generated by the wind tunnel, and/or downloaded test data corresponding to a threshold value. For example, the system may determine that a test has begun upon determining that data meeting a certain threshold (e.g., a real-time test velocity of Mach 1.1) is stored in the common data storage 130.

In step 504 data including “real-time” data collected during a test is optionally downloaded to a common storage area (e.g., common data storage are 130) and thereafter transmitted to the user's computer (e.g., computer 102). Accordingly, the “real-time” data (i.e., the real-time data) may be slightly delayed. However, it is also envisioned that real-time data may also be transmitted to the user's computer 102 directly to a users computer before it is optionally saved in the common storage area. Accordingly, for the sake of clarity, it will be assumed that the real-time data refers to data generated during a corresponding wind tunnel test. The AirSpeed program can load and store at least some or all of the following data: (a) six aerodynamic force and moment coefficients in tunnel fixed, body fixed, or wind fixed axis systems as desired by user; (b) base and cavity correction information; (c) three parameter fin balance coefficients for up to four fins; (d) individual base and cavity pressures; (e) balance identification and uncertainties and can plot any of this information by itself or against other run data, as will be described below.

Next, in step 506, the system (e.g., via computer 102) determines whether the real-time data corresponds to one or more threshold values. In other words, the real-time data is compared to one or more threshold values so that it can be determined whether the real-time data is greater than, less than, and/or equal to the one or more threshold values, as desired. The threshold value may also correspond to a predetermined range (e.g., a range of angles, settings, etc.) or within a predetermined tolerance (e.g., ± a given setting). Accordingly, based on the determination in step 506, the method continues to step 508 to process the data according to a users setting (e.g., if it is determined that the data corresponds with a threshold value) or continues to step 512.

In step 508 the system according to the present invention processes the data according to predetermined and/or user settings, saves the processed data in one or more corresponding wind tunnel test matrices, and thereafter displays the data in step 510 according to user settings. However, in step 506, if the real-time data is determined not to meet the one or more predetermined threshold values (i.e., is out of tolerance), the system flags the out of tolerance data for later review and/or notifies the user (e.g., via display 112 and/or speaker—not shown) in step 512 and optionally repeats the run which was determined to be defective. The erroneous data is then saved (or moved) to an error database for later evaluation and the run number is removed from the AirSpeed test matrix display. Accordingly, real-time test data downloaded from a shared user directory can be checked in real-time during a corresponding test procedure. If the data is determined not to meet the thresholds, a corresponding aerodynamic test run can be repeated before a model change is performed. Accordingly, valuable wind tunnel time can be saved and user cost minimized.

Accordingly, out of tolerance runs may be repeated as necessary so that data that meets predetermined values or ranges may be obtained. Moreover, by interfacing with the facility performing the test run, the computer, according to the present invention, can use the AirSpeed program to download real-time test run data so that the user does not have to do so manually, thus enhancing user convenience.

The AirSpeed program according to the present invention also provides means for performing user-defined operations on any of the data parameters (such as test run parameters) saved in the one or more corresponding wind tunnel test matrices. Accordingly, the system and method according to the present invention can plot any of these data parameters by itself or against other run data. Additionally, the run data can be splined, merged, differenced, or modified as desired. The AirSpeed program can also assigned new run numbers as a function of the operation(s) performed to modified runs and can compare and evaluate repeated runs with respect to stored balance uncertainties, as desired. The AirSpeed program according to the present invention can then save any downloaded, created, or modified data, as desired in the one or more corresponding wind tunnel test matrices in graphic form as charts, etc. This is better illustrated with reference to FIG. 6 below.

The test run parameters screened by the AirSpeed program can include parameters such as Mach and Reynolds numbers, Fin deflections, pitch (α), roll (φ), and/or sideslip angle (β) for sweeps at corresponding conditions, sweep range to assure obtaining a desired range of data, and foul indication. Accordingly, during a test run, if any real-time data is determined to be out of specification (e.g., the real-time data does not meet the threshold value or tolerance or does not lie within a predetermined range of values or tolerance), then a warning to this extent is output visually or audibly via a display or speaker means, respectively, warning of the condition.

A screen shot illustrating a wind tunnel test matrix and a corresponding graph according to the present invention is shown in FIG. 6. Wind tunnel test matrix 600 includes information such as Mach numbers in column 601, configuration number in column 603, pitch data (a) in Columns 605. As shown, dialog box 621 is superimposed upon the wind tunnel test matrix 600 and displays options for a user's selection so that variables such as pitch and roll for can be selected for graphing in graph 610 as shown. With reference to graph 610, a coefficient of normal force (CNW) is shown plotted against roll angle for three selected fin settings. These type of plot is an example of one aerodynamic coefficient that may be monitored while conducting the test. A better example would include comparisons to comparable data from another test if available.

After completing a wind tunnel test and filling one or more corresponding wind tunnel test matrices with the tunnel data, this data can be evaluated using the same AirSpeed program to provide the post test analysis. For example, the individual data runs as acquired from the tunnel and displayed in the “run matrix” view and identified by run number can be splined to common pitch, yaw, or roll breakpoints and merged into tables of two or more independent variables for further manipulation. These tables are given a unique name and are displayed in the “table matrix” view and thereafter can be further corrected to remove balance uncertainties (“tare corrected”), incremented with respect to fin deflection, configuration type, or any user defined increment, and finally adjusted to enforce pre-defined symmetry constraints. These modified or corrected tables are identified and saved after each operation via a unique naming criterion. In addition within the stored tables a written record of the operation including date, time, and runs used or operated on is included.

Additionally, system and method using the AirSpeed program according to the present invention provides means for forming and saving a history of all operations performed on any of the obtained data within a corresponding table Moreover, means for comparing the corrected tables to the original data runs is also provided Moreover, means are provided to operate on tabular data such that it can be added, differenced, merged, interpolated, extrapolated, scaled, copied, edited, etc., as desired by a user. The resultant data can then be displayed and/or saved either in tabular form (e.g., in a corresponding matrix) or graphically (e.g., in a chart), as desired. Moreover, the AirSpeed program can perform operations on the obtained data individually or in a single large batch operation mode, including control increments, configuration differences, or custom differences, merge data obtained via multiple sweeps into single table, provides means for naming tables to reflect the data contained within and/or the operations performed upon the data, and provides mean for plotting the tabular which is formed by the AirSpeed program against in-test results or to other test data. Additionally the AirSpeed program can form data in tables having multiple dimensions. For example, the formed data can be output in tables having up to 5 dimensions and displayed in tabular or graphic form via, for example, a printer or display.

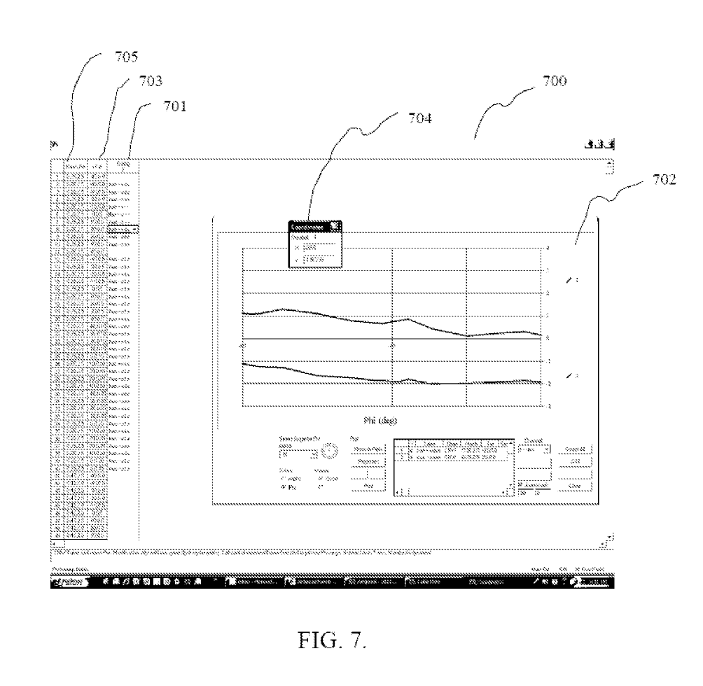

A screen shot illustrating a wind tunnel test matrix and a corresponding graph according to the present invention is shown in FIG. 7. Window 700, includes a table containing parameters such as Mach numbers, configuration number, and control deflections are shown in rows 670, 703, and 705, respectively. Graph window 702 is superimposed upon window 700 and includes graphs of incremental CNW due to a control deflection plotted against roll angle for two selected fin settings for data corresponding to the table shown in window 700. User entry boxes such as a selected alpha angle for selecting a corresponding alpha angle to plot, x-axis variables, refresh option, zooming option for zooming in on data points, etc., channel selection, etc., are provided to the user such that the user can select various settings as desired e.g., see, window 704 which provides x and y axis coordinates for a given data set option. Additionally from the graphic display screen 702 the user can graphically edit the table data to automatically smooth points through alpha or phi, or adjust points individually. Additionally, a user can change between aerodynamic configurations using a channel entry, can add other data corresponding with predetermined settings for comparison, etc. by selecting other selections in window 702. Accordingly, a user can narrow a desired range of options for precise calculation and display of test data.

While the present invention has been described with detail according to computerized means for planning a wind tunnel test program using estimated run times, model change times, and tunnel cost factors, the present invention can also be used for planning tests in other fluids, such as water, etc. Moreover, the present invention can be used for forming aerodynamic test data matrices and discriminating data. Furthermore, the present invention can be used for authenticating aerodynamic tests. While the above description contains many specifics, these specifics should not be construed, as limitations of the invention, but merely as exemplifications of preferred embodiments thereof. Those skilled in the art will envision many other embodiments within the scope and spirit of the invention as defined by the claims appended hereto.

What is claimed is:

1. A system for planning and supporting a testing routine in a fluidic chamber, comprising a controller for downloading first data related to one or more fluidic chambers, the first data including cost and run-time information for each of the one or more fluidic chambers, comparing the first data to second data corresponding to predetermined constraints, determining one or more run plans based upon the comparison, selecting an optimized run plan of the one or more run plans, and displaying the optimized run plan.

2. The system of claim 1, further comprising a common data base for receiving test data obtained during the optimized run plan, wherein the controller receives test data during a corresponding test.

3. The system of claim 2, wherein the controller compares the test data to one or more threshold values, and determines whether the test data corresponds with the one or more predetermined threshold values during a corresponding test.

4. The system of claim 3, wherein when the test data is determined not to correspond with the one or more threshold values, the controller informs of the determination.

5. The system of claim 1, wherein the one or more fluidic chambers is a wind tunnel.

6. The system of claim 1, further comprising a display for displaying the result of the determination.

7. The system of claim 1, wherein the controller loads the test data such that the test data corresponds to predetermined sweep times.

8. A method for planning and supporting a testing routine in a fluidic chamber, comprising:
downloading, by a controller, first data related to one or more fluidic chambers, the first data including cost and run-time information for each of the one or more fluidic chambers;
comparing the first data to second data corresponding to predetermined constraints;
determining one or more run plans based upon the comparison;
selecting an optimized run plan of the one or more run plans; and
displaying the optimized run plan.

9. The method of claim 8, further comprising receiving, from a common data base, test data obtained during the optimized run plan, wherein the test data is received during a corresponding test.

10. The method of claim 9, further comprising:
comparing the test data to one or more predetermined threshold values; and
determining whether the test data corresponds with the one or more threshold values during a corresponding test.

11. The method of claim 10, wherein when the test data is determined not to correspond with the one or more predetermined threshold values, the controller informs of the determination.

12. The method of claim 8, wherein the one or more fluidic chambers is a wind tunnel.

13. The method of claim 8, further comprising a display for displaying the result of the determination.

14. The method of claim 8, wherein the controller loads the test data such that the test data corresponds with predetermined sweep times.
